(19) United States
(12) Patent Application Publication
(10) Pub. No.: US 2021/0317765 A1
(43) Pub. Date: Oct. 14, 2021

(54) EXHAUST HEATING SYSTEM FOR MOTOR VEHICLES POWERED BY AN INTERNAL COMBUSTION ENGINE

(71) Applicant: Vaness, LLC, Solon, OH (US)

(72) Inventor: Christopher C. WHIPPLE, Solon, OH (US)

(73) Assignee: Vaness, LLC, Solon, OH (US)

(21) Appl. No.: 17/220,201

(22) Filed: Apr. 1, 2021

Related U.S. Application Data
(60) Provisional application No. 63/006,752, filed on Apr. 8, 2020.

(51) Int. Cl. F01N 3/20; F01N 9/00

(52) U.S. Cl. CPC F01N 3/2013; F01N 9/00; F01N 2900/10; F01N 2900/08; F01N 2900/1404

(57) ABSTRACT

An exhaust gas heating system and method for rapidly heating an exhaust gas produced by an internal combustion engine upstream from a catalytic converter. The exhaust gas heating system includes a heating element in the form of a multi-layer ceramic heater that is capable of heating to 1800° F. within 4 to 8 seconds to rapidly increase the temperature of the exhaust gas passing through an exhaust pipe during a cold start phase of the ICE. A control system is programmed to activate and deactivate the heating element. Rapid heating of the ICE exhaust gas allows the catalytic converter to be more efficiently and completely clean and purify the exhaust gas during the cold start phase of the ICE.

### RELATED APPLICATIONS

This application claims the benefit of U.S. Provisional Application No. 63/006,752 filed Apr. 8, 2020, which is hereby fully incorporated herein by reference.

### FIELD OF THE INVENTION

The present invention relates generally to an exhaust heating system for an internal combustion engine that improves the operational performance of a catalytic converter, and more particularly to an exhaust heating system for gasoline and diesel engine powered vehicles that improves the pollution reduction provided by a catalytic converter.

### BACKGROUND OF THE INVENTION

Catalytic converters have long been used for the treatment of exhaust gas produced by an internal combustion engine (ICE) that powers a motor vehicle. Effective operational performance of the catalytic converter significantly reduces the pollution emissions of the ICE. The temperature of exhaust gas produced by the ICE during cold engine conditions (i.e., the ICE cold start phase) is below the temperature of the exhaust gas produced by the ICE during normal operating conditions. Although exhaust gas temperatures during normal operating conditions will vary with the type of ICE, fuel, ignition quality, compression ratio, and other engine parameters, the temperature of exhaust gas during normal operating conditions is typically in the range of 750° F. to 1650° F.

One problem encountered with the use of catalytic converters is that the catalysts for converting undesirable components in a stream of exhaust gas produced by an ICE-powered motor vehicle are not effective at the low exhaust gas temperatures that exist during the cold start phase of the ICE. In this regard, catalytic converters are fully functional only when the exhaust gas temperature is within a range of at least 300° F. to 500° F. For this reason, when the ICE is in a cold start phase, the pollution emitted from the exhaust system of the motor vehicle will be at its highest.

Although the catalytic converter has prevented billions of pounds of pollution from being emitted into the earth's atmosphere since it was first introduced in the mid 1970's, it continues to have drawbacks during the cold start phase of an ICE due to its inability to effectively operate at the lower exhaust gas temperatures.

In order to obtain effective operational performance of the catalytic converter, there is a need in the prior art for very rapid and efficient heating of the exhaust gas during the cold start phase of an ICE.

The present invention provides an apparatus and that rapidly and efficiently heats the exhaust gas produced by an ICE during a cold start phase to improve the operational performance of a downstream catalytic converter.

### SUMMARY OF THE INVENTION

In accordance with the present invention, there is provided an exhaust heating system that includes: a heating element for heating exhaust gas produced by an internal combustion engine (ICE) upstream of a catalytic converter for removing pollutants from the exhaust gas; a temperature sensor for measuring a temperature of the exhaust gas produced by the ICE; and a control system for activating and deactivating the heating element, wherein the control system receives the temperature of the exhaust gas from the temperature sensor.

In accordance with another aspect of the present invention, there is provided a method of heating an exhaust gas produced by an internal combustion engine (ICE) upstream of a catalytic converter. The method includes the steps of (a) activating a multi-layer ceramic heater by applying power thereto, when it is determined that the ICE is in the cold start phase or in response to an input signal indicative of a vehicle start-up condition; and (b) using the multi-layer ceramic heater to heat the exhaust gas to a temperature that is high enough to allow the catalytic converter to efficiently remove pollutants from the exhaust gas.

An advantage of the present invention is the provision of an exhaust heating system that rapidly heats exhaust gas produced by an ICE to a temperature as high as 1800° F., prior to the exhaust gas being received downstream by a catalytic converter.

Another advantage of the present invention is the provision of an exhaust heating system that allows a catalytic converter to operate at higher efficiency to clean and purify exhaust gas prior to emission of the exhaust gas into the surrounding environment.

These and other advantages will become apparent from the following description of illustrated embodiments taken together with the accompanying drawings and the appended claims.

### BRIEF DESCRIPTION OF THE DRAWINGS

The invention may take physical form in certain parts and arrangement of parts, a preferred embodiment of which will be described in detail in the specification and illustrated in the accompanying drawings which forms a part hereof, and wherein:

FIG. 1 is a block diagram of an exhaust heating system, according to an embodiment of the present invention, as used in connection with a conventional catalytic converter for an ICE; and

FIG. 2 is a schematic diagram of the exhaust heating system of FIG. 1

### DETAILED DESCRIPTION OF THE INVENTION

As discussed above, the exhaust of an ICE-powered motor vehicle is only properly cleaned and purified by a catalytic converter when the temperature of the exhaust gas produced by the ICE has reached a temperature that is high enough to allow the catalytic converter to efficiently remove pollutants from the exhaust (i.e., typically a temperature in the range of at least 300° F. to 500° F.). Before the exhaust gas reaches a temperature for full functioning of the catalytic converter, all of the exhaust gas pollutants are emitted via the motor vehicle's exhaust system. A fully functioning catalytic converter provides oxidation and reduction of the exhaust gas, including nitrogen oxides, carbon monoxide, and hydrocarbons. During full functioning of the catalytic converter, these components of the exhaust gas become less hazardous substances, such as carbon dioxide, water vapor, and nitrogen gas. It should be appreciated that the term ICE, as used herein, includes, but is not limited to, gasoline and diesel engines.

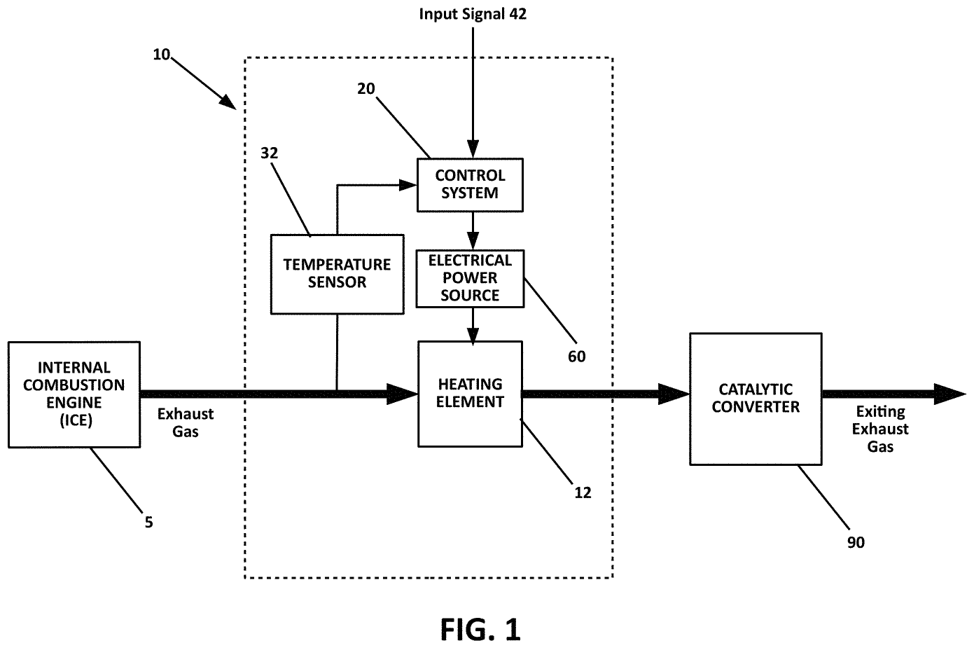

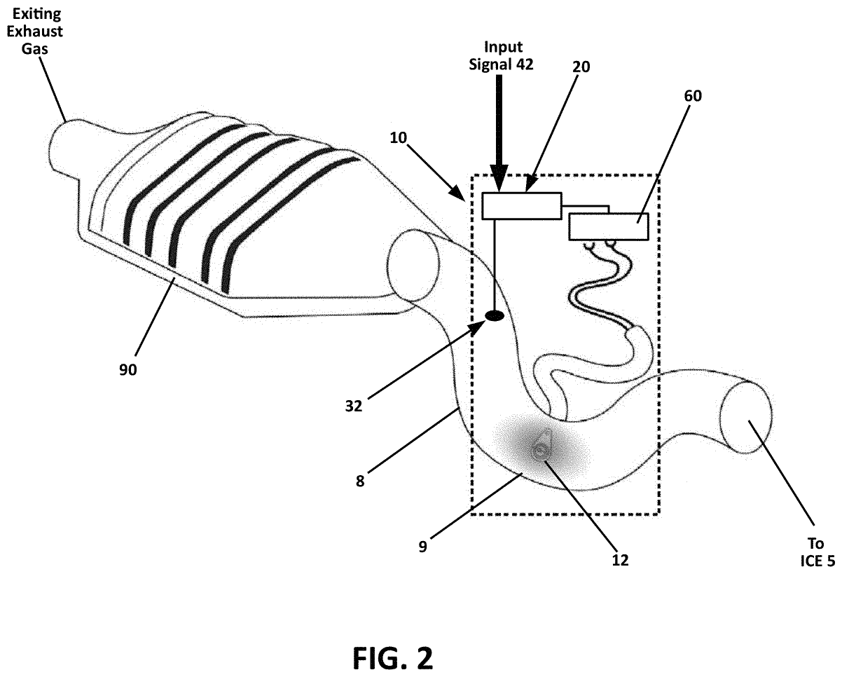

Referring now to the drawings wherein the showings are for the purposes of illustrating an embodiment of the present invention only and not for the purposes of limiting same, FIGS. 1 and 2 show an exhaust heating system 10 according to an embodiment of the present invention. Exhaust heating system 10 is generally comprised of a heating element 12, a control system 20, a temperature sensor 32, and an electrical power source 60.

Heating element 12 is located inside, or adjacent to, an exhaust pipe 8 extending between an internal combustion engine (ICE) 5, such as a gasoline or diesel engine, and a conventional catalytic converter 90. The catalytic converter 90 receives exhaust gas produced by ICE 5 via exhaust pipe 8 to reduce toxic gases and pollutants therein. Catalytic converter 90 may take the form of (i) a two-way catalytic converter, which oxidizes carbon monoxide to carbon dioxide and oxidizes hydrocarbons (unburnt and partially burned fuel) to carbon dioxide and water, or (ii) a three-way catalytic converter, which also controls the emission of nitric oxide and nitrogen dioxide. Exhaust gas exiting catalytic converter 90 is output to the surrounding environment. Heating element 12, located upstream of catalytic converter 90, rapidly heats the exhaust gas traveling through exhaust pipe 8, as will be explained in detail below.

In accordance with the illustrated embodiment of the present invention, heating element 12 takes the form of a multi-layer ceramic heater that is capable of heating to a temperature of 1800° F. in approximately 4 to 8 seconds. For example, it is contemplated that the multi-layer ceramic heater may take the form of the 12V multi-layer ceramic heater as disclosed in U.S. Pat. No. 10,183,553, which is fully incorporated herein by reference. The multi-layer ceramic heater preferably includes one or more miniature silicon nitride gas igniters selected from the group comprising silicon nitride, molybdenum disilicide, and mixtures thereof that draw 2.5 A to 3.5 A from a standard 12V electrical system. The present invention recognizes that a multi-layer ceramic heater has significant advantages over other types of conventional heating elements, including, but not limited to, faster heating to temperatures around 1800° F., lower power consumption, and lower production costs.

In one embodiment of the present invention, the multi-layer ceramic heater is comprised of silicon nitride and molybdenum disilicide containing 75 volume percent of silicon nitride and 25% by volume of molybdenum disilicide, wherein the particle size of the silicon nitride is larger than the particle size of the molybdenum disilicide. In this embodiment, the multi-layer heater also includes a mass of liquid coolant that is heated, and a temperature sensing element for detecting the temperature of the liquid coolant.

In the illustrated embodiment, temperature sensor 32 may take the form of a conventional exhaust gas temperature sensor (EGTS), such as those available from Delphi Technologies and Denso for gas and diesel-powered vehicles. Such temperature sensors can typically provide precise temperature measurements in the range of −40° F. to 1850° F. An EGTS may use a resistance temperature sensor or thermocouple for temperature measurements.

Control system 20 may take the form of a conventional electronic controller or computer system. It is also contemplated that the main control system of the ICE-powered vehicle may serve as control system 20. Control system 20 receives data from temperature sensor 32 indicative of the temperature of the exhaust gas in exhaust pipe 8. As will discussed below, control system 20 is programmed to activate and deactivate heating element 12 by controlling electrical power to heating element 12 (i.e., applying and discontinuing power to heating element 12). In an embodiment of the present invention, electrical power source 60 is the 12V battery of the gas or diesel-powered vehicle. It is also contemplated that electrical power source 60 may an auxiliary battery that is used solely to power heating element 12.

Operation of exhaust heating system 10 will now be described in detail. Exhaust produced by ICE 5 travels through exhaust pipe 8 towards catalytic converter 90. The exhaust gas is processed as it travels through catalytic converter 90, and is emitted to the surrounding environment after exiting catalytic converter 90.

In accordance with a method according to one embodiment of the present invention, control system 20 is programmed to activate heating element 12 when it detects ICE 5 is in a cold start phase. For example, temperature sensor 32 may detect an ambient temperature indicating that ICE 5 is in a cold start phase. Control system 20 activates heating element 12 by providing electrical power to heating element 12 from power source 60. As described above, heating element 12 may take the form of a multi-layer ceramic heater. Accordingly, heating element 12 heats to approximately 1800° F. within about 4 to 8 seconds after activation by control system 20. As a result, the exhaust gas in exhaust pipe 8 is rapidly heated as it passes therethrough, upstream of catalytic converter 90.

In another embodiment, control system 20 is programmed to activate heating element 12 in response to a received input signal 42. Input signal 42 may be a signal from the vehicle computer system indicating a vehicle start-up condition, such as the moving of a vehicle door lock from a locked position to an opened position, or a signal from the vehicle indicating that a vehicle door has been opened. It is contemplated that other input signals commonly associated with a vehicle star-up condition or an ICE cold start phase may be used as input signal 42 to control system 20. Control system 20 may also be programmed to deactivate heating element 12 in response to the ICE 5 not being started within a predetermined time period (Tstart) following the unlocking of a vehicle door or opening of a vehicle door. For example, Tstart may be about 30 seconds.

In one embodiment of the present invention, control system 20 is programmed to deactivate heating element 12 when the temperature measured by the temperature sensor 32 is indicative of the exhaust gas reaching a predetermined setpoint temperature (T_{SP}), such as 600° F. As indicated above, catalytic converters efficiently operate when the exhaust gas is at least 300° F. to 500° F.

In an alternative embodiment, control system 20 is programmed to deactivate heating element 12 when a predetermined heat time (t_{H}) has elapsed, e.g., about 600 seconds. After heating element 12 has been activated for t_{H}, it is determined that the exhaust gas has reached a temperature that allows for efficient operation of catalytic converter 90. Control system 20 calculates the time that heating element 12 is activated and compares the activation time to t_{H}.

In yet another embodiment of the present invention, control system 20 is programmed to deactivate heating element 12 when one of the following conditions occurs: (a) the temperature measured by the temperature sensor 32 is indicative of the exhaust gas reaching a predetermined setpoint temperature (T_{SP}), or (b) a predetermined heat time (t_{H}) has elapsed, whichever occurs first.

As mention above, in one embodiment of the present invention, heating element 12 takes the form of a multi-layer ceramic heater comprised of silicon nitride and molybdenum disilicide, containing 75 volume percent of silicon nitride and 25% by volume of molybdenum disilicide, with a silicon nitride particle size that is larger than the molybdenum disilicide particle size. This multi-layer ceramic heater also includes a mass of liquid coolant that is heated, and a temperature sensing element for detecting the temperature of the liquid coolant. Accordingly, in this embodiment, temperature sensor 32 is the temperature sensing element of the multi-layer ceramic heater, since the temperature measured by the temperature sensing element is indicative of the temperature of the exhaust gas in exhaust pipe 8. In accordance with this embodiment of the present invention, control system 20 is programmed to deactivate the multi-layer ceramic heater, based upon the temperature measured by temperature sensor 32 (i.e., the temperature sensing element of the multi-layer ceramic heater). Thus, control system 30 deactivates heating element 12 when the temperature measured by the temperature sensor 32 is indicative of the exhaust gas reaching a predetermined setpoint temperature (T_{SP}), such as 600° F.

It should be appreciated that it is believed a bend 9 formed in exhaust pipe 8 (as shown in FIG. 2) upstream of the catalytic converter will promote more efficient mixing of the hot exhaust gas with cooler exhaust gas. Thus, it is believed advantageous to the present invention to include a bend in exhaust pipe 8 in the region where the exhaust gas is being heated by heating element 12.

The present invention is directed to an apparatus and method for rapidly heating the exhaust gas produced by an ICE to a temperature as high as 1800° F. during a cold start phase of the ICE. As a result, the catalytic converter operates more efficiently during the cold start phase of the ICE, i.e., the catalytic converter provides greater oxidation and reduction of the ICE's exhaust during the cold start phase of the ICE. It is believed that use of the present invention can reduce emissions from ICE-powered motor vehicles by as much as 50%, as compared to existing systems

The foregoing describes specific embodiments of the present invention. It should be appreciated that these embodiments are described for purposes of illustration only, and that numerous alterations and modifications may be practiced by those skilled in the art without departing from the spirit and scope of the invention. For example, while the present invention has been described with reference to gasoline and diesel-powered vehicles, it is also contemplated that the present invention may also find utility in other ICE applications, including, but not limited to, construction, agriculture, and mining equipment powered by ICEs. It is intended that all such modifications and alterations be included insofar as they come within the scope of the invention as claimed or the equivalents thereof.

What is claimed is:

1. An exhaust heating system comprising:
a heating element for heating exhaust gas produced by an internal combustion engine (ICE) upstream of a catalytic converter for removing pollutants from the exhaust gas;
a temperature sensor for measuring a temperature of the exhaust gas produced by the ICE; and
a control system for activating and deactivating the heating element, wherein the control system receives the temperature of the exhaust gas from the temperature sensor.

2. The exhaust heating system according to claim 1, wherein said heating element is a multi-layer ceramic heater.

3. The exhaust heating system according to claim 2, wherein the multi-layer ceramic heater heats to a temperature of 1800° F. within 8 seconds of activation

4. The exhaust heating system according to claim 1, wherein said heating element is (a) located in an exhaust pipe extending between the internal combustion engine (ICE) and the catalytic converter, or (b) located proximate to an exhaust pipe extending between the internal combustion engine (ICE) and the catalytic converter.

5. The exhaust heating system according to claim 1, wherein said temperature sensor senses the temperature of the exhaust gas in the exhaust pipe.

6. The exhaust heating system according to claim 1, wherein said control system activates the heating element when detecting that the ICE is in a cold start phase.

7. The exhaust heating system according to claim 1, wherein said control system activates the heating element in response to an input signal indicative of a vehicle start-up condition.

8. The exhaust heating system according to claim 1, wherein said control system activates the heating element in response to an input signal indicative of a vehicle door lock moving from a locked position to an opened position

9. The exhaust heating system according to claim 1, wherein said control system activates the heating element in response to an input signal indicative that a vehicle door has been opened.

10. The exhaust heating system according to claim 1, wherein said control system deactivates the heating element in response to the ICE not being started within a predetermined time period (Tstart) following unlocking of a vehicle door.

11. The exhaust heating system according to claim 1, wherein said control system deactivates the heating element in response to the ICE not being started within a predetermined time period (Tstart) following opening of a vehicle door.

12. The exhaust heating system according to claim 1, wherein said control system deactivates the heating element when the temperature measured by said temperature sensor is indicative of the exhaust gas reaching a predetermined setpoint temperature (T_{SP}).

13. The exhaust heating system according to claim 1, wherein said control system deactivates the heating element when a predetermined heat time (t_{H}) has elapsed.

14. The exhaust heating system according to claim 1, wherein said control system deactivates the heating element when one of the following conditions occurs: (a) the temperature measured by the temperature sensor is indicative of the exhaust gas reaching a predetermined setpoint temperature (T_{SP}), or (b) a predetermined heat time (t_{H}) has elapsed, whichever occurs first.

15. A method of heating an exhaust gas produced by an internal combustion engine (ICE) upstream of a catalytic converter, said method comprising:
activating a multi-layer ceramic heater by applying power thereto, when it is determined that the ICE is in the cold start phase or in response to an input signal indicative of a vehicle start-up condition; and
using the multi-layer ceramic heater to heat the exhaust gas to a temperature that is high enough to allow the catalytic converter to efficiently remove pollutants from the exhaust gas.

16. The method of heating according to claim 15, wherein the method further includes:
deactivating the multi-layer ceramic heater by discontinuing power thereto in response to a measured temperature of the exhaust gas produced by the ICE reaching a predetermined setpoint temperature (T_{SP}).

17. The method according to claim 15, wherein said input signal is indicative of a vehicle door lock moving from a locked position to an opened position or indicative that a vehicle door has been opened.

18. The method according to claim 15, wherein the method further includes:
deactivating the multi-layer ceramic heater in response to the ICE not being started within a predetermined time period (Tstart) following unlocking of a vehicle door or opening of a vehicle door.

19. The method according to claim 15, wherein the method further includes:
deactivating the multi-layer ceramic heater by discontinuing power thereto, in response to a predetermined heat time (t_{H}) elapsing.

20. The method according to claim 15, wherein the method further includes:
deactivating the multi-layer ceramic heater by discontinuing power thereto, when one of the following conditions occurs: (a) to a measured temperature of the exhaust gas produced by the ICE reaches a predetermined setpoint temperature (T_{SP}), or (b) a predetermined heat time (t_{H}) has elapsed, whichever occurs first.
